(19) United States
(12) Patent Application Publication
(10) Pub. No.: US 2013/0155048 A1
(43) Pub. Date: Jun. 20, 2013

(54) THREE-DIMENSIONAL GRAPHICS CONSTRUCTION AND USER INTERFACE

(71) Applicant: Raghavendra H. Swamy, Bangalore (IN)

(72) Inventor: Raghavendra H. Swamy, Bangalore (IN)

(73) Assignee: ADVANCED MICRO DEVICES, INC., Sunnyvale, CA (US)

(21) Appl. No.: 13/325,859

(22) Filed: Dec. 14, 2011

(51) Int. Cl. G06T 15/00

(52) U.S. Cl. 345/419

(57) ABSTRACT

A method and apparatus for a three-dimensional (3D) user interface are provided. The 3D user interface enables a user to interact with 3D applications on computing devices utilizing a 3D display. The 3D user interface utilizes a swarm algorithm to perform computations on 3D graphical objects in a graphics engine. The swarm algorithm allows multiple 3D graphics objects to interact with each other to form the 3D graphics of the application.

### FIELD OF INVENTION

The present invention is generally directed to three-dimensional (3D) graphics generation.

### BACKGROUND

A user interface plays an important role in interfacing a computer to the outside world. Through the user interface a user can interact with the computer, issue commands to the computer and instruct the computer to perform complex operations. The user interface has evolved over the years from simple switching or toggle lights to a character-based command line to a two-dimensional (2D) graphics interface.

Presently, mobile phones, televisions, computers, and other electronic devices are equipped with three-dimensional (3D) displays. Three-dimensional displays can support a 3D graphical user interface. However, the user interfaces of present day electronic devices are not 3D, but are instead 2D. Certain 2D user interfaces apply various shading and shadowing effects to give their 2D graphics a 3D effect.

Furthermore, many electronic devices are equipped with processors that are optimized for graphics processing such as graphics processing units (GPUs), and accelerated processing units (APUs). These processors are typically equipped with parallel processing and multi-threading capabilities, which allow the processors to handle 3D graphics rendering for gaming and other graphics applications.

It is, therefore, desirable to have a method and apparatus for constructing 3D graphical objects that utilize the parallel computing capabilities of graphics processors. It is also desirable to have a 3D user interface that allows for immersive interaction of a user with a computer system.

### SUMMARY OF EMBODIMENTS OF THE INVENTION

A method and apparatus for generating three-dimensional (3D) graphical objects are provided. In the method and apparatus, graphical computations for constructing a 3D graphical object are distributed over a plurality of 3D agents using a swarm algorithm, where each 3D agent represents a graphical computation. Further, in the method and apparatus, the 3D agents may be provided to a runtime layer, where the runtime layer manages the execution of the 3D agents on a processor. Additionally, in the method and apparatus the 3D agents are executed by the processor.

In the method and apparatus, the 3D graphical object may be displayed on a display, where the display may be a 3D display. The 3D graphical object may be part of a user interface. Additionally, the processor may be a graphics processing unit (GPU), an accelerated processing unit (APU), or a general purpose GPU (GPGPU), and may be equipped with parallel processing capability.

### BRIEF DESCRIPTION OF THE DRAWINGS

A more detailed understanding may be had from the following description, given by way of example in conjunction with the accompanying drawings, wherein:

FIG. 1 is a block diagram of a computer system;

FIG. 2A is an example of a web browser application in a 3D user interface;

FIG. 2B is an example of a search engine application in a 3D user interface;

FIG. 3 is a flow diagram of a method for constructing 3D graphics; and

FIG. 4 is a flow diagram of a method for constructing 3D graphics.

### DETAILED DESCRIPTION OF THE EMBODIMENTS

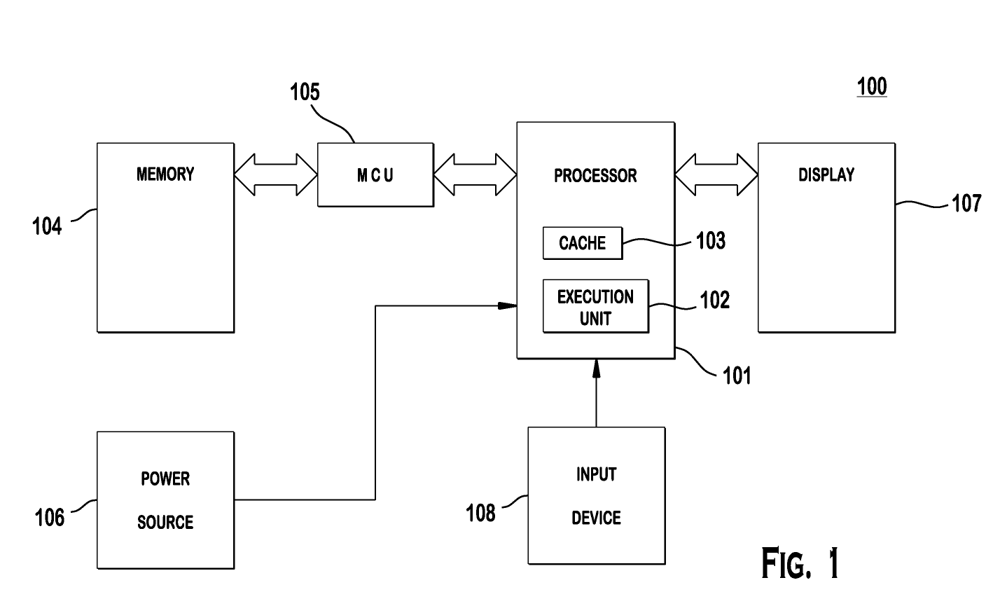

FIG. 1 shows a block diagram of a computer system 100. The computer system 100 includes a processor 101. The processor may be a controller, a digital signal processor (DSP), a central processing unit (CPU), a graphics processing unit (GPU), or an integrated processing unit having both graphics and general-purpose computing capabilities in what is known in the art as an accelerated processing unit (APU). The processor 101 may also be a GPU that is capable of performing general purpose computing tasks in what is known in the art as general purpose computation on GPU (GPGPU). The processor 101 may have parallel computing capabilities and may be multi-threaded.

Although the computer system 100 is shown to have only one processor 101, it is understood that the computer system 100 may have any number of processors. These processors may be homogeneous, where all the processors are the same kind, e.g., all the processors are CPUs, or all the processors are GPUs, or the processors may be heterogeneous, where the processors may, for example, be a combination of CPUs and GPUs or other types of processors (e.g., DSPs, etc.).

The execution unit 102 is the computational engine of the processor 101. The processor 101 is also equipped with a cache 103 for storing readily-accessible instructions and data. The cache 103 may be hierarchical and may have various levels, e.g., Level 1 (L1), Level 2 (L2), etc., that vary in both size and access time. Further, the cache 103 may be on- or off-chip or on- or off-die with the processor 101.

The processor 101 operates on data stored in cache 103 or in memory 104. The memory 104 may be system memory or disc storage and may be volatile or non-volatile. Examples of system memory include Random Access Memory (RAM), Dynamic RAM (DRAM), Synchronous DRAM (SDRAM), Static RAM (SRAM), Read-Only Memory (ROM), and electrically erasable programmable ROM (EEPROM), among others that are known in the art. Examples of disc storage include a hard drive (HD) and a solid-state drive (SSD), among others. Furthermore, memory 104 may be external to the computer system 100, where it may be cloud-based, i.e., stored off-site, where it is managed by a server and accessible to the processor 101 via a network connection. The memory 104 may also be in a network-attached storage (NAS) or a storage area network (SAN).

The processor 101 accesses the memory 104 using a memory controller unit (MCU) 105. The MCU 105 manages access to the memory 104 and requests data to be loaded from the memory 104 and sends data to be stored in the memory 104.

The computer system 100 is equipped with an input device 108 that allows a user to provide input the computer system 100. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless Institute for Electrical and Electronics Engineering (IEEE) 802 signals).

The computer system 100 is further equipped with a power source 106 which provides electric power to the circuitry of the computer system 100. The computer system 100 is also equipped with a display 107 for displaying user information. The display 107 may be a three-dimensional (3D) display that is capable of displaying 3D graphics.

Computer system 100 requires an operating system for managing its components and providing services to the user. The operating system also provides a software platform on which application programs may run. Examples of operating systems for computer system 100 include Android™, iPhone operating system (iOS), and Windows®. The operating system has a user interface for the user to interact with the computer system 100.

Computer system 100 may also support an application programming interface (API). An API is a computing standard for providing programs that execute on the computer system 100. Examples of an API include Open Graphics Library (OpenGL®) which is used in programs that execute on GPUs to produce 2D and 3D graphics, and Open Computing Language (OpenCL™) which is used in programs that execute on computer systems having both graphics and general purpose computing capabilities. For example, computer systems that have both a CPU and a GPU, or computer systems that have an APU, or a GPGPU may support OpenCL™.

A user interacts with computer system 100 via a user interface. The user interface allows the user to utilize the computational capabilities of the computer system 100 and run application programs on the computer system 100. A 3D user interface adds a depth element over a 2D interface and provides the user more flexibility when interacting with a computer system 100. Furthermore, the 3D user interface provides a real-world feel to the interaction between the user and the computer system 100.

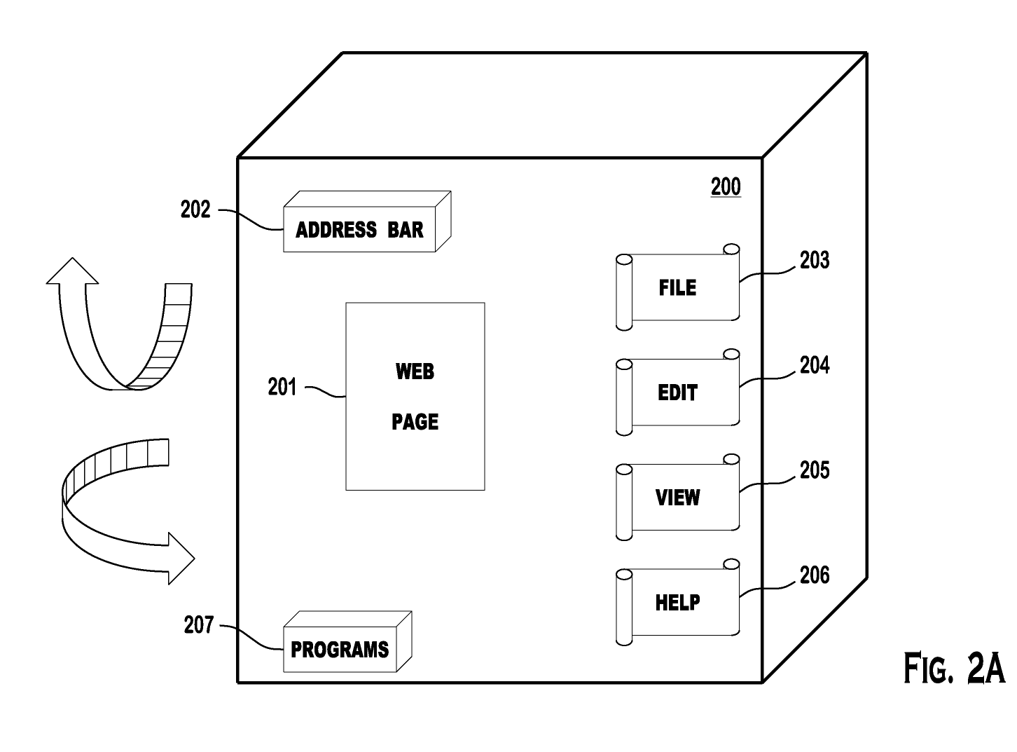

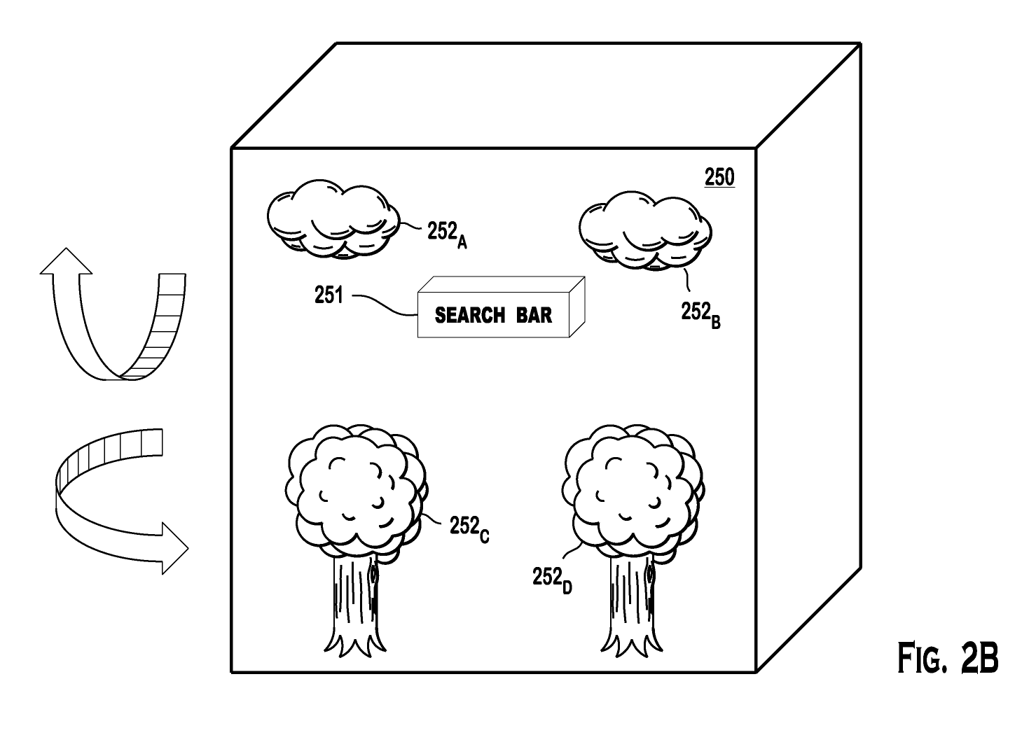

FIG. 2A shows an example of a web browser application in a 3D user interface 200 (e.g., desktop environment). The web browser application includes a web page 201, an address bar 202, and menu items 203-206 that are associated with the web browser application. Further, 3D user interface 200 has a programs bar 207, which allows the user to access other applications by, for example, clicking on the program bar 207. It is recognized that a user may interact with a 3D user interface 200 using various inputs devices. Examples of such input devices, in addition to those described herein, include a 3D mouse, and motion sensing devices, (e.g., XBOX Kinect™, Sony Wii™ remote, or Razer Hydra). Further, a user may have a third-person view of the user interface and may be able to navigate the user interface in 3D space, (e.g., using 3D crosshairs).

When displayed on a 3D display or a 2D display that supports 3D graphics, address bar 202, and menu items 203-206 of the user interface 200 are viewed by a user as 3D objects. Web page 201 may be viewed as a 2D object or a 3D object depending on its nature. By way of example, when web page 201 is a news article, it may be best viewed in a 2D plane because a user associates a news article with text on a page, which is planar in nature. However, when web page 201 is a 3D animation, then it may be best viewed in 3D so that the user may better appreciate the 3D animation. Further, unlike 2D user interfaces, which confine applications to 2D windows, the 3D objects of user interface 200 may be windowless. With a 3D user interface a user may change the orientation of the web page 201, the address bar 202, and menu items 203-206 by turning them in any direction in 3D space.

FIG. 2B shows an example of a search engine application in a 3D user interface 250. The search engine application has a 3D search engine bar 251 and other 3D objects 252_{A-D}. The search engine bar 251 may be located anywhere in 3D space and a user of the search engine may change the orientation of the search engine bar 251 or the other 3D objects 252_{A-D} as desired in 3D space. Because of the added dimension of the 3D user interface, search results may be displayed in full home page view populated in 3D space rather than as line-by-line captions as customary in 2D user interfaces.

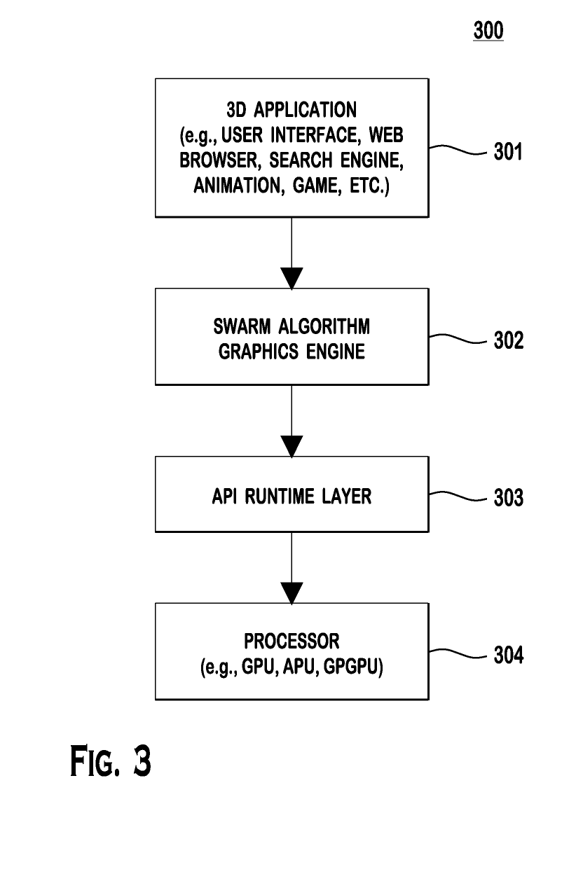

FIG. 3 shows a flow diagram of a method 300 for constructing 3D graphics. At the 3D application 301 level, an application determines a 3D graphical object requiring construction or rendering. The 3D application 301 may be a 3D user interface, 3D user applications, (e.g., 3D web browser, 3D desktop, 3D media player, or 3D file directory), 3D games, 3D animation, or another application for rendering graphics in 3D. The 3D application 301 may also be a 2D application that is being mapped to 3D. The 3D graphical object requiring construction or rendering may be an icon, a menu item, a check box, or a pixel among others.

The 3D application 301 invokes a swarm algorithm graphics engine 302 for the construction of the 3D graphical object. The 3D application 301 may invoke the swarm algorithm engine 302 by performing a function call. The swarm algorithm graphics engine 302 utilizes a swarm algorithm for distributing the graphics computations required for constructing the 3D graphical object. Swarm algorithms are based on swarm intelligence and are derived from collective behavior in natural and species. In swarm algorithms, swarm agents perform assigned tasks, where the result of the tasks, when taken collectively, produces a global behavior. Examples of swarm algorithms include the ant colony algorithm (ACA), which is an optimization algorithm based on the behavior of ants in a colony, and the bee algorithm, which is based on the behavior of swarms of bees, and is used in solving job scheduling problems. Other examples of the swarm algorithm include the school of fish behavior algorithm, firefly behavior algorithm, intelligent water drops behavior algorithm, particle swarm behavior, river flow algorithm, among others. In swarm algorithms, agents, (e.g., ants or bees), are assigned to perform tasks, the totality of which results in a global outcome.

The swarm algorithm graphics engine 302 uses a swarm algorithm to distribute graphics computations required for constructing the 3D graphical object over multiple 3D agents. Each 3D agent may represent a graphics computation such as a shading, rasterization, or culling operation. The 3D agents in the swarm algorithm engine 302 are, therefore, analogous to the ants or bees in a swarm and are each associated with a task. Using a swarm algorithm, various computations related to the construction of a 3D graphical object are assigned to 3D agents based on swarm intelligence.

Each 3D agent representing a graphical computation may be executed on a core of a multi-core processor, or on a single thread of a multi-threaded processor. Further, when a processor is equipped with parallel computing capabilities, the 3D agents may be executed in parallel on the processor. The swarm algorithm graphics engine 302 may utilize one or more swarm algorithms in assigning computing tasks to each 3D agent.

The 3D agents are then provided to an API runtime layer 303. The runtime layer supports the execution of 3D agents on the processor 304. The API runtime layer 303 may perform scheduling operations, create input/output buffers for data transfers, and queue the operations associated with the 3D agents in a command queue for execution. The API runtime layer may support an API such OpenGL as is the case when processor 304 is a GPU or OpenCL when processor 304 is a CPU, APU, or GPGPU. Operations associated with the 3D agents are then executed by processor 304, which may be a CPU, GPU, APU, GPGPU, as previously described.

The 3D application 301, swarm algorithm graphics engine 302, and API runtime 303 of method 300 may run on a processor for general purpose computing such as a CPU, GPGPU, or a general purpose computing portion of an APU, whereas the execution of operations associated with the 3D agents may be performed by a graphics processor, such as a GPU, GPGPU, or a graphics processing portion of an APU.

It is also recognized that the method 300 is advantageous for processing on a GPU, APU, or GPGPU since the method 300 is able to exploit the parallel processing capabilities of the GPU, APU, or GPGPU to produce 3D graphical objects. Using the method 300, 3D agents of the swarm algorithm may execute on parallel threads of a multi-threaded processor and, therefore, allowing for fast and efficient construction of 3D graphical objects.

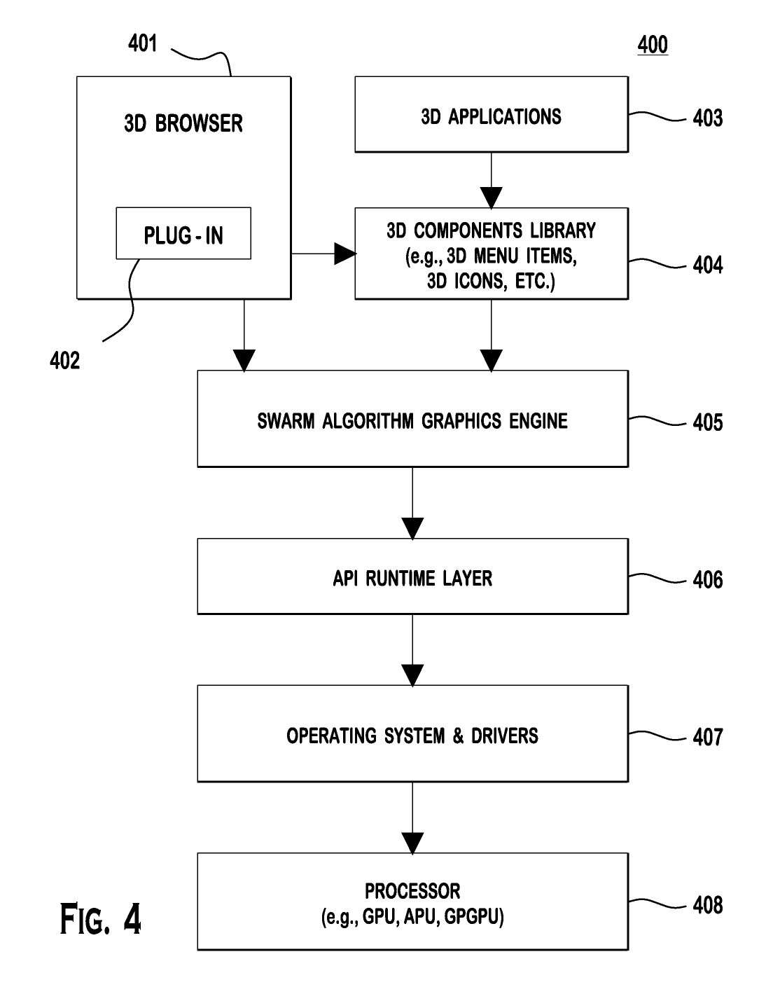

FIG. 4 shows a flow diagram of a method 400 for constructing 3D graphics. In the method 400, a 3D browser 401 is equipped with a plug-in 402. The plug-in 402 comprises software components that enable the 3D browser 401 to parse browser script or tags describing a web page. The script may be a mark-up language for describing 3D graphics such as 3D mark-up language for web (3DMLW), which is utilized in 2D browser applications for displaying 3D content.

The plug-in 402 may utilize a 3D components library 404 for constructing 3D graphical objects for the 3D browser 401. The 3D components library 404 may comprise 3D menu items, (e.g., 3D menu items 203-206 of FIG. 2A), floating items, or 3D icons, that are used in standardizing the graphics of various applications. Alternatively, the plug-in 402 may have its own library of 3D components and may not be required to use 3D components library 404.

In the method 400, 3D applications 403 (e.g., 3D desktop, 3D media player, or 3D file directory) may also utilize 3D components library 404 for constructing 3D graphical objects. The 3D browser 401 or the 3D application 403 invoke a swarm algorithm graphics engine 405 for constructing 3D graphical objects. The swarm algorithm graphics engine 405 provides 3D agents to an API runtime layer 406, as described herein. The API runtime layer 406 supports the execution of the 3D agents. The API runtime layer 406 also interfaces with operating system and drivers 407 and invokes routines in the operating system and driver 407 for the execution of the 3D agents. The operating system and drivers 407 facilitate the execution of the 3D agents on the processor 408. The processor 408 then executes the 3D agents.

Embodiments of the present invention may be implemented using C, C++, or Java, among other programming languages that are known in the art. Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Although features and elements are described above in particular combinations, each feature or element may be used alone without the other features and elements or in various combinations with or without other features and elements. The methods provided may be implemented in a general purpose computer, a processor or any IC that utilizes power gating functionality. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions (such instructions capable of being stored on a computer readable media). The results of such processing may be maskworks that are then used in a semiconductor manufacturing process to manufacture a processor which implements aspects of the present invention.

What is claimed is:

1. A method for generating three-dimensional (3D) graphical objects, the method comprising:
distributing graphical computations for constructing a 3D graphical object over a plurality of 3D agents using a swarm algorithm, wherein each 3D agent represents a graphical computation;
executing the 3D agents by a processor.

2. The method of claim 1, further comprising:
displaying the 3D graphical object on a display.

3. The method of claim 2 wherein the display is a 3D display.

4. The method of claim 1 wherein the 3D graphical object is part of a user interface.

5. The method of claim 1 wherein the processor is a graphics processing unit (GPU), an accelerated processing unit (APU), or a general purpose GPU (GPGPU).

6. The method of claim 1 wherein the processor is equipped with parallel processing capability.

7. The method of claim 1 wherein the swarm algorithm is an ant colony algorithm (ACA), a bee algorithm, school of fish behavior algorithm, or river flow algorithm.

8. A computer system for generating three-dimensional (3D) graphical objects, the computer system comprising:
memory configured to store operational instructions and data for execution by a first processor;
a first processor configured to distribute graphical computations for constructing a 3D graphical object over a plurality of 3D agents using a swarm algorithm, wherein each 3D agent represents a graphical computation, the first processor further configured to provide the 3D agents to a runtime layer, wherein the runtime layer manages the execution of the 3D agents on a second processor; and
a second processor configured to execute the 3D agents.

9. The computer system of claim 8, further comprising:
a display configured to display the 3D graphical object.

10. The computer system of claim 9 wherein the display is a 3D display.

11. The computer system of claim 8 wherein the 3D graphical object is part of a user interface.

12. The computer system of claim 8 wherein the first processor is a central processing unit (CPU), an accelerated processing unit (APU), or a general purpose GPU (GPGPU).

13. The computer system of claim 8 wherein the second processor is a graphics processing unit (GPU), an accelerated processing unit (APU), or a general purpose GPU (GPGPU).

14. The computer system of claim 8 wherein the second processor is equipped with parallel processing capability.

15. The computer system of claim 8 wherein the swarm algorithm is an ant colony algorithm (ACA), a bee algorithm, school of fish behavior algorithm, or river flow algorithm.

16. A computer-readable storage medium storing a set of instructions for execution by a general purpose computer for generating three-dimensional (3D) graphical objects, the set of instructions comprising:
a distributing code segment for distributing graphical computations for constructing a 3D graphical object over a plurality of 3D agents using a swarm algorithm, wherein each 3D agent represents a graphical computation;
a providing code segment for providing the 3D agents to a runtime layer, wherein the runtime layer manages the execution of the 3D agents on a processor;
an executing code segment for executing the 3D agents by the processor.

17. The computer-readable storage medium of claim 16, further comprising:
a displaying code segment for displaying the 3D graphical object on a display.

18. The computer-readable storage medium of claim 17 wherein the display is a 3D display.

19. The computer-readable storage medium of claim 16 wherein the swarm algorithm is an ant colony algorithm (ACA), or a bee algorithm.

20. The computer readable storage medium of claim 16, wherein the set of instructions are hardware description language (HDL) instructions used for the manufacture of a device.
